(19) United States
(12) Patent Application Publication
(10) Pub. No.: US 2005/0073966 A1
(43) Pub. Date: Apr. 7, 2005

(54) Method and apparatus for identifying devices supporting multicast channel allocation protocol (MCAP) on the same network and multicast communication method using the same

(75) Inventors: Jae-Hwa Kim, Gyeonggi-do (KR); Il-Ju Na, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/341,496

(22) Filed: Jan. 14, 2003

(30) Foreign Application Priority Data
Mar. 7, 2002 (KR) 2002-12153

(51) Int. Cl. H04H 1/00

(52) U.S. Cl. 370/312

(57) ABSTRACT

A method of determining whether devices support a Multicast Channel Allocation Protocol (MCAP), and a multicast communication method using the same. The method includes an MCAP device broadcasting an MCAP advertise message to a plurality of devices on a network, the MCAP device, which broadcasts the MCAP advertise message, broadcasting an Internet Group Management Protocol (IGMP) query message to the plurality of devices on the network, and the MCAP device, which broadcasts the MCAP advertise message, determining whether each of the plurality of devices on the network supports the MCAP using channel numbers through which a plurality of IGMP report messages was transmitted from the plurality of devices on the network. By doing so, calculation loads caused by unnecessarily using broadcast channels, even when all devices included in a multicast group on the IEEE1394 network support the MCAP, can be prevented.

### CROSS-REFERENCE TO RELATED APPLICATIONS

This application claims the benefit of Korean Patent Application No. 2002-12153, filed Mar. 7, 2002, in the Korean Industrial Property office, the disclosure of which is incorporated herein by reference.

### BACKGROUND OF THE INVENTION

1. Field of the Invention

The present invention relates to a method of determining, when devices supporting a Multicast Channel Allocation Protocol (MCAP) and devices not supporting the MCAP are on the same network, whether or not the devices support the MCAP, and a multicast communication method using the same.

2. Description of the Related Art

In the related art multicast communication method, a multicast using broadcast channel is performed regardless of whether devices on the same network, for example, on an IEEE1394 network, support the MCAP. In this case, although some devices support the MCAP, the broadcast method is unnecessarily used and the MCAP function itself is nullified. As a result, a selective transmission function, which is the core function of the multicast communication, cannot be used.

FIG. 1 is a schematic diagram showing a unicast method, a broadcast method, and a multicast method.

In the unicast transmission method, one source transmits data to one destination. Ordinary Internet application programs use the unicast method. Meanwhile, in the broadcast transmission method, one source transmits data to all destinations on the same subnetwork.

In the multicast transmission method, one or more sources transmit data to one or more predetermined destinations. The multicast transmission method is used in an Internet video conference application.

When the same data is to be transmitted to a plurality of destinations for group communication, if the unicast transmission method is employed, data packets to be transmitted should be sent to each destination several times. With this redundant transmission of the same packets, the network efficiency is degraded, and if the number of destinations increases, this problem becomes worse.

Meanwhile, if the multicast transmission is supported, the source can transmit a message at one time, and the wasting of network resources due to the redundant transmission of data can be minimized.

The multicast transmission is different from the ordinary unicast transmission, first, in the transmission packets. In general, in an Internet application program on a TCP/IP protocol, the source of data marks the Internet address of a destination that will receive the data in the header of the transmission packet and then transmits the packet. However, for multicast transmission, a group address to which a plurality of destinations belong, instead of the address of one destination, is marked and then the packet is transmitted.

The group address for multicast transmission is a D-cass IP address (for example, 224.0.0.1-239.255.255.254), which, unlike A, B, and C-class IP addresses that indicate respective Internet hosts all over the world, does not indicate an actual host. A destination that receives a multicast packet having a group address determines whether to receive the packet by determining whether the destination is included in the group of the packet.

IP multicast addressing is an Internet standard specified in RFC112 (Host Extensions for IP Multicasting), which is supported by many workstation manufacturers (SUN, SGI, DEC, HP, etc.), and is formally defined as D-class IP addressing.

The address range of the D class is from 224.0.0.1 to 239.255.255.254. These addresses are not exclusively allocated to a predetermined host but rather are actively allocated to one multicast group, which is different from the previous address allocation methods.

A workstation that can recognize and support D-class IP addresses communicates information with other workstations using two addresses of multicast groups, the first being the address to which the workstation belongs or wants to belong, and the second being an address that is exclusively allocated to the workstation. An Internet Group Management Protocol (IGMP) specifies a method for use by a host that wants to form a new group or enter a group. Thus, a formed multicast group is represented by a session display (sd), which is a leading representation means. With the sd, multicast groups being operated at present and members of the groups can be identified.

Meanwhile, the IEEE1394 technology, which has attracted attention as a next-generation home network interface technology, has been developed originally as a hard disc interface by Apple Co. since 1986. Later, with IBM and Sony's participation, standardization has proceeded. In 1994, the 1394 Trade Association was established to make the IEEE1394 public.

In 1995, standard specifications for IEEE1394 were formally approved in the name of ‘IEEE Std 1394-1995’. In the standard specifications, three high-speed transmission speeds, 100 Mbps, 200 Mbps, and 400 Mbps, are specified. Also, IEEE Std 1394a-2000 standard was specified in 2000 by adding functions to and complementing IEEE Std 1394-1995.

FIG. 2 is a schematic diagram showing the relationships between layers in IEEE1394. IEEE1394-1995 is the standard for hardware and software composed of three layers, including a physical layer, a link layer, and a transaction layer. The functions of the three layers and the relationships between the layers are shown in FIG. 2. Usually, an IEEE1394 host adaptor performs functions of the physical layer and the link layer, while a host is responsible for the transaction layer and a bus management function. The physical layer usually performs an arbitration function for obtaining an authority to use a serial bus, and the data link layer performs control of bus cycles. The transaction layer performs basic functions, e.g., read and write, of a network device and manages resources needed in isochronous transmission relating to the bus control function.

The interface of the IEEE1394 is basically a serial interface formed by 6 copper wires, including two pairs of signal lines and a pair of power lines. The two pairs of signal lines are used in a half-duplex mode where one pair is used in transmitting a data signal, while the other pair is used in transmitting a timing signal for data sampling synchronization. The reason for using the pair of timing signal lines is to avoid a burden of doubling the transmission speed when transmitting data includes timing information such as Manchester coding due to the high transmission speed.

Devices that support the IEEE1394 are referred to as nodes. The physical connection method most widely used is a tree structure, and a bus structure is widely used as an operating method. That is, at an arbitrary time, only one node can transmit data while all other nodes connected to the node can receive the data.

Specifications for supporting IP multicast on an IEEE1394 network are defined by draft-ieft-ip1394-ipv6 and draft-ietf-ip1394-mcap of Internet Engineering Task Force (IETF), which is a research committee under the Internet Architecture Board (IAB) that develops Internet standard specifications, and IPv4 is defined by RFC2734(IPv4 over IEEE1394). These specifications specify that an IP multicast packet is supported using either an asynchronous stream transmission mode or an isochronous stream transmission mode. Here, a mode to be used is determined according to the characteristic of service request of the IP packet. That is, the asynchronous stream method is used for a packet requesting Best-Effort services, while the isochronous stream method is used for a packet requesting Quality of Service (QoS).

In these two transmission methods, channel numbers instead of node numbers, are used in transmission. Processes for allocating and returning a channel number and allocating a bandwidth are performed using a Multicast Channel Allocation Protocol (MCAP) in a Channel Allocation Manager (CAM). The CAM receives a request from a multicast source or a group participant and allocates a multicast channel and a bandwidth. The request/response packet used at this time uses the MCAP protocol.

The MCAP defines two methods for allocating channels. In the first method, all nodes (devices supporting the IEEE1394) performing the IP function use broadcast channel which is basically commonly shared. In the second method, a channel other than the broadcast channel is used.

In the first method, multicast communication can be performed without additional protocols, but unnecessary packets are received such that calculation loads to the devices increase.

In the second method, a channel for a predetermined multicast group address is allocated to a device belonging to the predetermined multicast group. Through an MCAP advertise message, all devices on the network are made to know the connection between the allocated channel and the corresponding multicast address. All nodes on the network that receive the MCAP advertise message should transmit and receive the corresponding multicast packet through the allocated channel.

When all devices on an IEEE1394 network use the broadcast channel as the first method, multicast communications do not cause a problem. However, by performing broadcast, unnecessary packets inevitably cause calculation loads on the devices that are not included in the corresponding multicast group.

When all devices on the network are MCAP supporting devices that interpret the MCAP message and then adjust the channels, as the second method, multicast communications do not cause a problem either. In this case, the reception of unnecessary packets can be minimized.

Thus, there is no problem in multicast communications either when all devices do not support the MCAP function or when all devices support the MCAP function.

However, at present only some of the nodes on the IEEE1394 network support the MCAP, and devices supporting the MCAP and devices not supporting the MCAP coexist on the network. Therefore, by the inconvenient broadcast method, multicast communications are performed.

FIGS. 3A&B are schematic diagrams showing the prior art multicast communications method on an IEEE1394 network.

The prior art multicast communications method on the IEEE1394 network uses a method in which one multicast message is transmitted to all devices through a broadcast channel (channel 31), as shown in FIG. 3A. In this case, the method can be formed such that all devices can broadcast a multicast message, regardless of MCAP devices 302 and 306 and non-MCAP devices 304.

However, for example, if the MCAP device 306 performs multicast communication by allocating another channel, for example, channel 7, as shown in FIG. 3B, instead of using the broadcast channel, a problem occurs.

That is, if the MCAP device 306 allocates channel 7 to a multicast address (for example, 239.255.255.250) and transmits an MCAP message, and the MCAP device 302 which recognizes this transmits a multicast message having an address of 239.255.255.250 through channel 7, the non-MCAP device 304 cannot receive the multicast message.

Therefore, if the non-MCAP devices, which do not support the MCAP and can perform multicast only by broadcast channel, and the MCAP devices are on the same network, there is a problem in communicating between the two types of devices.

That is, though an MCAP device allocates a channel other than a broadcast channel to a predetermined multicast address and informs this to all devices on the network through an MCAP advertise message, non-MCAP devices cannot receive a packet having a channel different from the broadcast channel because the non-MCAP devices are made to communicate a multicast through a broadcast channel.

This may cause a serious problem in a home network environment. In the home network environment surely to be introduced in the future, all home appliances, including mobile phones, Internet phones, digital automatic response machines, pagers, refrigerators, and toasters, as well as all imaginable computer products, including personal computers, notebook computers, palmtop computers, TV Set-Top Boxes (STB), video game players, printers, modems, and scanners, will all be connected together.

Devices are connected to a host in a home network system by a network Plug and Play (PnP) function.

For example, UNIVERSAL PLUG AND PLAY (UPnP), which was developed by MICROSOFT CO., is a kind of a network PnP such as JINI developed by SUN MICROSYSTEMS.

UPnP uses a new network protocol as an arbitrator which interactively connects the devices. That is, like the hypertext transmission protocol (HTTP), regardless of the types of computers connected to a web server, HTTP protocol is appropriately distributed to requested places. Actually, from WINDOWS 2000, Internet Printing Protocol is supported so that a user can remotely print a document using a printer connected to a network. The IPP protocol is not dependent on the operating system of the user, printer manufacturers, or the types of computers.

Meanwhile, in JINI, JAVA takes the same role as the IPP of Microsoft. Most PCs of today download and operate Java applets from a server only if the PCs have web browsers supporting Java. Therefore, using this, in JINI, JAVA applets that recognize devices are supported, frequently downloaded, and if not necessary, are made to disappear from the machine. At the core of JINI, there is Remote Method Invocation (RMI). Particularly from the viewpoint of a user, it is advantageous because the process of downloading and deleting JAVA applets cannot be recognized by human eyes.

In the home network having changeability and scalability by the network PnP, it is necessary to efficiently manage traffic between devices on the IEEE1394 network, and in particular, it is necessary to prevent transmission of unnecessary packets for multicast communication.

### SUMMARY OF THE INVENTION

Accordingly, it is an aspect of the present invention to provide a method of determining whether devices on the same network support a Multicast Channel Allocation Protocol (MCAP).

It is a second aspect of the present invention to provide a multicast communication method using the method described above.

Additional aspects and advantages of the present invention will be set forth in part in the description that follows, and, in part, will be obvious from the description, or may be learned by practicing the present invention.

To accomplish the above aspects and for other aspects of the present invention, there is provided a method for determining whether an MCAP is supported on a network, the method including an MCAP device broadcasting an MCAP advertise message to a plurality of devices on a network, the MCAP device, which broadcasts the MCAP advertise message, broadcasting an Internet Group Management Protocol (IGMP) query message to the plurality of devices on the network, and the MCAP device, which broadcasts the MCAP advertise message, determining whether each of the plurality of devices on the network supports the MCAP using channel numbers through which a plurality of IGMP report messages was transmitted from the plurality of devices on the network.

To accomplish the aspects and for other aspects of the present invention, there is provided a multicast communication method on a network, the method including an MCAP device belonging to a multicast group broadcasting an MCAP advertise message to a plurality of devices on a network, the MCAP device, which broadcasts the MCAP advertise message, broadcasting an IGMP query message to the plurality of devices on the network, the MCAP device, which broadcasts the MCAP advertise message, determining whether each of the plurality of devices on the network supports the MCAP using channel numbers through which a plurality of IGMP report messages was transmitted from the plurality of devices on the network, and performing communication with a corresponding multicast address by using a multicast channel if the plurality of IGMP report messages from all of the plurality of devices to which the MCAP broadcast message was broadcast are received through the multicast channel, and performing communication with the corresponding multicast address by using broadcast channels if only some of the plurality of IGMP report messages from all of the plurality of devices are received through the multicast channel.

### BRIEF DESCRIPTION OF THE DRAWINGS

These and other aspects and advantages of the present invention will become apparent and more readily appreciated from the following description of the preferred embodiments, taken in conjunction with the accompanying drawings of which:

FIG. 1 is a schematic diagram showing a unicast method, a broadcast method, and a multicast method;

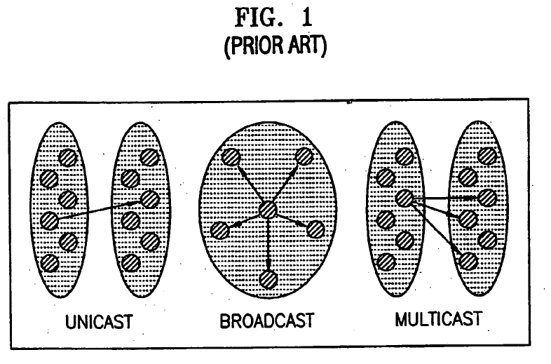

FIG. 2 is a schematic diagram showing the relationships between layers in IEEE1394;

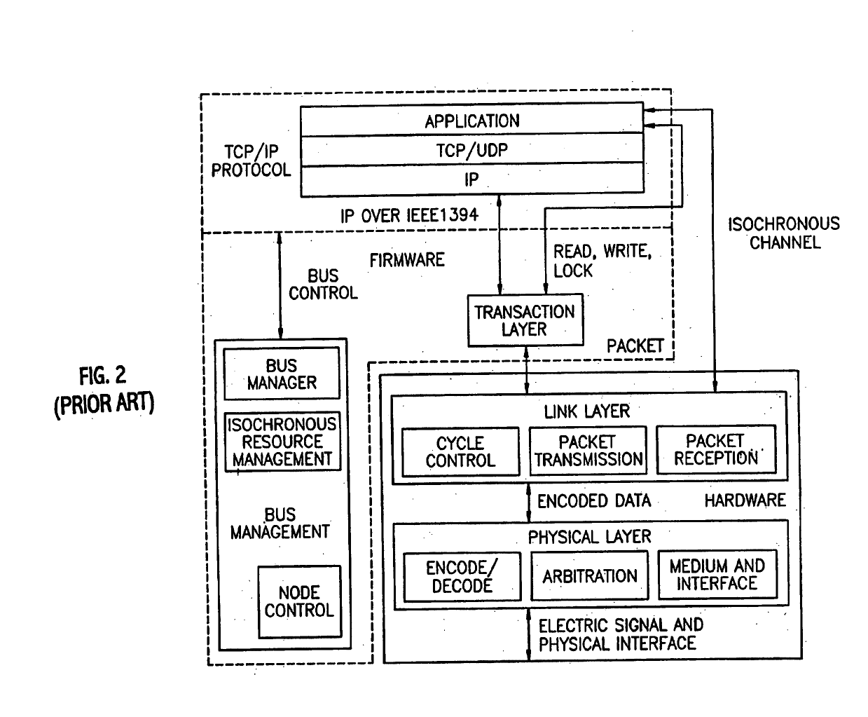

FIGS. 3A&B are schematic diagrams showing a conventional multicast communication method on an IEEE1394 network;

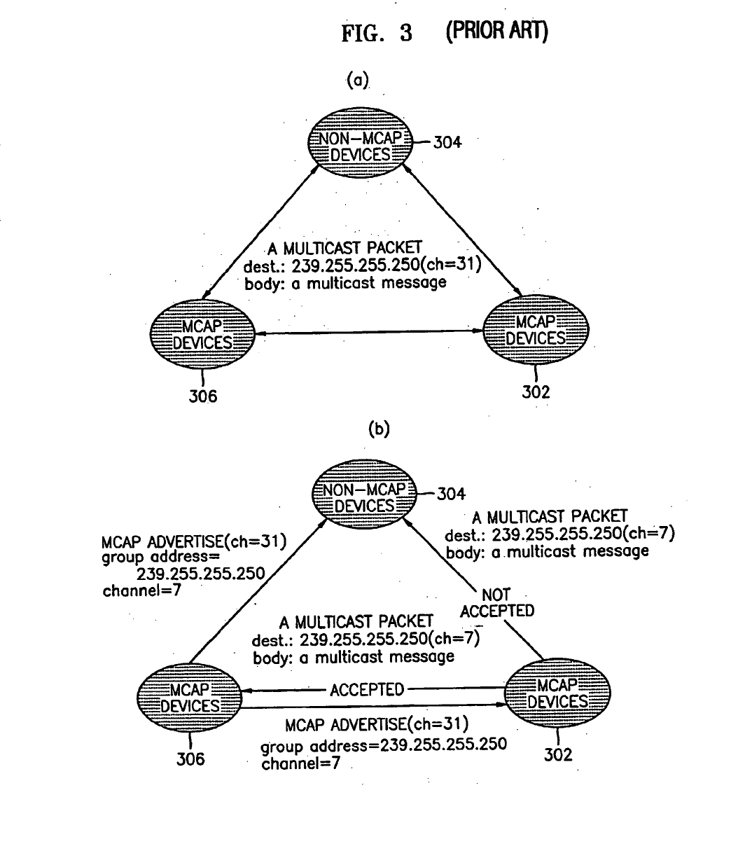

FIG. 4 is a flowchart showing a method for determining whether a Multicast Channel Allocation Protocol (MCAP) is supported;

FIG. 5 is a schematic diagram showing the method of FIG. 4;

FIG. 6 is a flowchart showing a multicast communication method according to an embodiment of the present invention; and

FIG. 7 is a schematic diagram showing the method of FIG. 6.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout.

Internet transmission methods can be divided into unicast, broadcast, and multicast methods from the viewpoint of source and destination.

In the present invention, by determining through an Internet Group Management Protocol (IGMP) query/report message whether non-Multicast Channel Allocation Protocol (MCAP) devices are on the same network, only when non-MCAP devices exist, MCAP devices use a broadcast channel, and if all devices support the MCAP, the MCAP protocol is used for multicast transmission.

By doing so, calculation loads caused by unnecessarily using broadcast channels, even when all devices belonging to a multicast group on the IEEE1394 network support the MCAP scan can be prevented. Also, even when non-MCAP devices are in the multicast group, multicast communication can be performed.

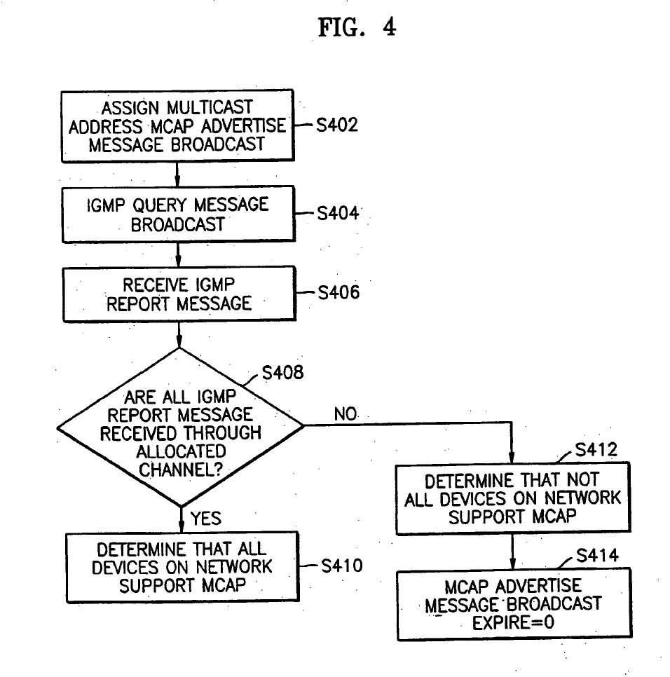

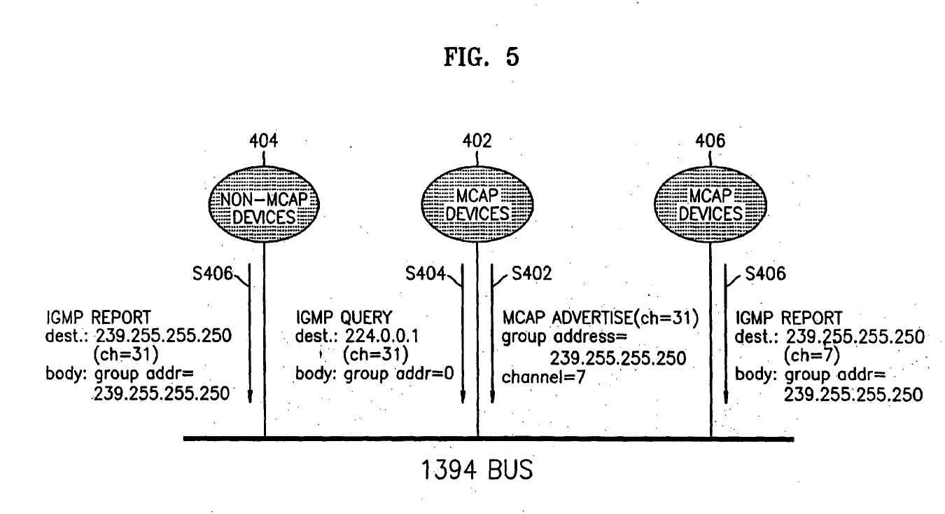

FIG. 4 is a flowchart showing a method for determining whether or not an MCAP is supported, and FIG. 5 is a schematic diagram showing the method of FIG. 4.

Referring FIGS. 4 and 5, the method for determining whether or not the MCAP is supported according to the present invention will now be explained.

First, as shown in FIG. 4, an MCAP device allocates an arbitrary channel other than a broadcast channel to a multicast address and then, through this multicast channel, broadcasts an MCAP advertise message to all devices on the IEEE1394 network in operation S402.

For example, as shown in FIG. 5, an MCAP device 402 belonging to multicast group 239.255.255.250 allocates channel 7 to a multicast address and then, through a broadcast channel (channel 31), broadcasts an MCAP advertise message to all devices on the same IEEE 1394 network.

Next, the MCAP device 402, which broadcasts the MCAP advertise message, also broadcasts an IGMP query message to all devices 404 and 406 on the same IEEE1394 network through the broadcast channel (channel 31) in operation S404.

The IGMP is for processing entry to/exit from the multicast group. The IGMP is used for a multicast router recognizing the existence of host group members on a corresponding subnet.

The IGMP basically uses a query message and a report message. The query message is a message with which the IGMP asks whether there is a host to enter a corresponding group. The query message is periodically transmitted to the subnet in order to check the current member of the group. The report message is a response to the query message which a host having an intention to enter the group transmits.

If the IGMP transmits a query message to a corresponding subnet, a host having the intention to enter the corresponding multicast group can enter the group by sending a report message. By not answering to the query message for a predetermined time, exit from a group can be accepted.

The MCAP device 402 broadcasts an IGMP query message on the multicast group 239.255.255.250 in operation S404.

The MCAP device 402, which broadcasts the MCAP advertise message, receives the IGMP messages from all devices on the same IEEE1394 network in operation S406.

The MCAP device 402, which broadcast the MCAP advertise message, determines whether or not the IGMP message transmitted from all devices on the same IEEE1394 network were transmitted through the allocated channel (channel 7) in operation S408.

The devices 404 and 406 belonging to the multicast group 239.255.255.250 on the IEEE1394 network transmit IGMP report messages as responses to the IGMP query message. The destination address of the IGMP report messages is the MCAP device that broadcasts the MCAP advertise message, that is, the MCAP device 402 that broadcasts the IGMP query message.

Since the MCAP device 406 already knows the channel number for the corresponding multicast address 239.255.255.250 by the received MCAP advertise message, the MCAP device 406 transmits the IGMP report messages through channel 7.

Meanwhile, since the non-MCAP device 404 does not recognize the MCAP advertise message, the non-MCAP device 404 transmits the IGMP report message through the broadcast channel (channel 31).

Therefore, by checking the channel numbers through which the IGMP messages are transmitted, the MCAP device 402 can determine whether or not each device 404 and 406 supports the MCAP.

If the IGMP messages transmitted from all devices on the same IEEE1394 network were transmitted through the allocated channel (channel 7), the MCAP device 402 determines that all devices on the same IEEE1394 network support the MCAP in operation S410.

If the IGMP messages transmitted from only some of the devices on the same IEEE1394 network were transmitted through the allocated channel (channel 7), the MCAP device 402 determines that only some of the devices on the same IEEE1394 network support the MCAP in operation S412.

The MCAP advertise message includes an expire time field. The expire time field is to set a time for maintaining a channel allocated by the MCAP advertise message. The MCAP device maintains the allocated channel for multicast for the time set in the expire time field.

If the IGMP messages transmitted by only some of the devices on the same IEEE1394 network were transmitted through the allocated channel (channel 7), it is not necessary to maintain the channel allocated by the MCAP advertise message.

Accordingly, in an embodiment, if the IGMP messages transmitted by only some of the devices on the same IEEE1394 network were transmitted through the allocated channel (channel 7), an MCAP advertise message having the content of ‘expire time=0’ is broadcast to all devices on the same network so that the channel allocated for multicast can be released in operation S414.

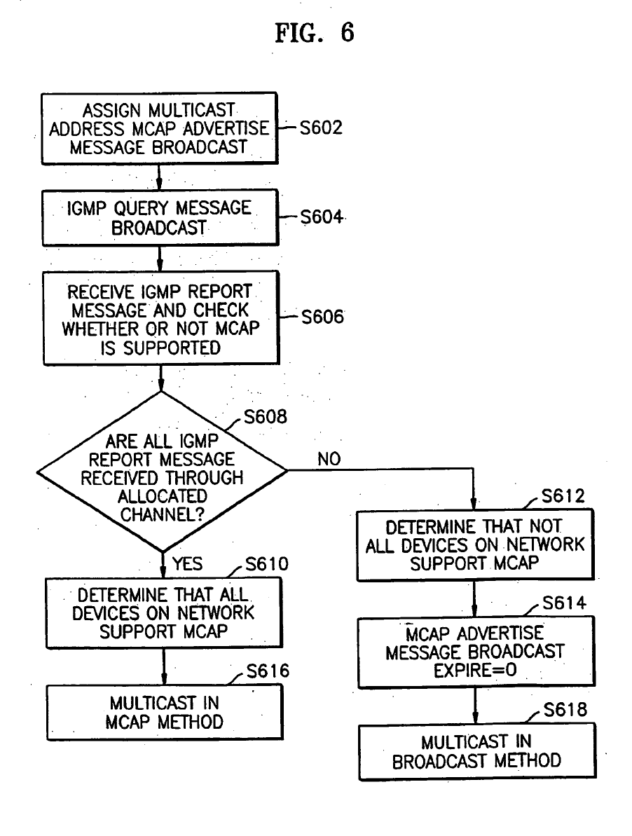

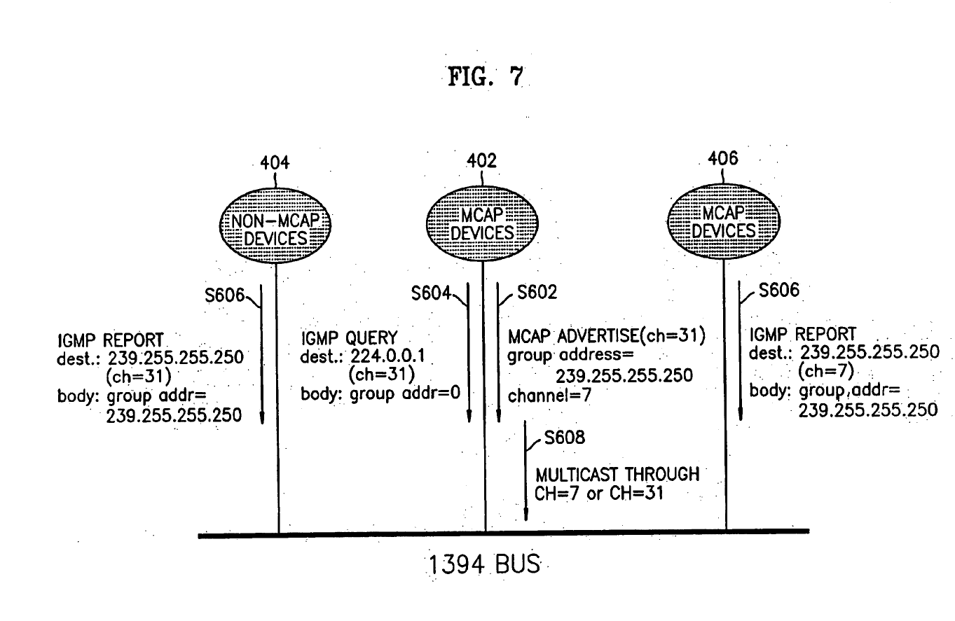

FIG. 6 is a flowchart showing a multicast communication method according to the present invention, and FIG. 7 is a schematic diagram showing the method of FIG. 6.

Referring to FIGS. 6 and 7, the method for multicast communication according to the present invention will now be explained.

First, as shown in FIG. 6, an MCAP device 402 belonging to a multicast group allocates an arbitrary channel (a multicast channel, for example, channel 7) other than broadcast channels to a multicast address and, through this multicast channel, broadcasts an MCAP advertise message to all devices on the same IEEE1394 network.

Next, the MCAP device 402, which broadcasts the MCAP advertise message, broadcasts an IGMP query message to all devices on the same IEEE1394 network in operation S604.

The MCAP device 402, which broadcasts the MCAP advertise message, receives IGMP messages from all devices on the same IEEE1394 network in operation S606.

The MCAP device 402, which broadcasts the MCAP advertise message, determines whether the IGMP messages transmitted from all devices on the same IEEE1394 network were transmitted through the allocated channel (channel 7) in operation S608.

The devices 404 and 406 belonging to the multicast group 239.255.255.250 on the IEEE1394 network transmit IGMP report messages as responses to the IGMP query message. The destination address of the IGMP report messages is the MCAP device that broadcasts the MCAP advertise message, that is, the MCAP device 402 that broadcasts the IGMP query message.

Since the MCAP device 406 already knows the channel number for the corresponding multicast address 239.255.255.250 by the received MCAP advertise message, the MCAP device 406 transmits the IGMP report message through channel 7.

Meanwhile, since the non-MCAP device 404 does not recognize the MCAP advertise message, the non-MCAP device 404 transmits the IGMP report message through the broadcast channel (channel 31).

Therefore, by checking the channel numbers through while the IGMP messages are transmitted, the MCAP device 402 can determine whether or not each device 404 and 406 supports the MCAR

If the IGMP messages transmitted from all devices on the same IEEE1394 network were transmitted through the allocated channel (channel 7), the MCAP device 402 determines that all devices on the same IEEE1394 network support the MCAP in operation S610. The MCAP device 402 performs communication with the corresponding multicast address by using the multicast channel in operation S616.

If the IGMP messages transmitted from only some of the devices on the same IEEE1394 network were transmitted through the allocated channel (channel 7), the MCAP device 402 determines that only some of the devices on the same IEEE1394 network support the MCAP in operation S612. The MCAP device 402 broadcasts an MCAP advertise message having the content of ‘expire time=0’ (immediately release) to all devices on the same network in operation S614.

The MCAP device 402 performs communication with the corresponding multicast address by using the broadcast channel in operation S616.

As shown in FIG. 7, the MCAP device 402 performs communication with the corresponding multicast address (239.255.255.250) through the allocated channel 7 if all the IGMP reports are received through the allocated channel 7 and broadcasts a message through the broadcast channel (channel 31) if any one IGMP report message was received through the broadcast channel (channel 31).

That is, if all devices belonging to a multicast group support the MCAP, multicast communication by the MCAP protocol is performed, whereas if there are non-MCAP devices, multicast communication by the broadcast method is performed.

Accordingly, calculation loads caused by unnecessarily using broadcast channels, even when all devices belonging to a multicast group on the IEEE1394 network support the MCAP, can be prevented. Also, even when non-MCAP devices are in the multicast group, multicast communication can be performed.

The components included in the system may include memories, processors, and/or Application Specific Integrated Circuits (“ASICs”). Such memory may include a machine-readable medium on which is stored a set of instructions (i.e., software) embodying any one, or all, of the methodologies described herein. Software can reside, completely or at least partially, within this memory and/or within the processor and/or ASICs. For the purposes of this specification, the term “machine-readable medium” shall be taken to include any mechanism that provides (i.e., stores and/or transmits) information in a form readable by a machine (e.g., a computer). For example, a machine-readable medium includes read only memory (“ROM”), random access memory (“RAM”), magnetic disk storage media, optical storage media, flash memory devices, electrical, optical, acoustical, or other form of propagated signals (e.g., carrier waves, infrared signals, digital signals, etc.), etc.

Although a few embodiments of the present invention have been shown and described, it would be appreciated by those skilled in the art that changes may be made in these embodiments without departing from the principles and spirit of the present invention, the scope of which is defined in the claims and their equivalents.

1. A method of determining whether a Multicast Channel Allocation Protocol (MCAP) is supported on a network, comprising:
broadcasting an MCAP advertise message to a plurality of devices on a network;
broadcasting an Internet Group Management Protocol (IGMP) query message to the plurality of devices on the network; and
determining whether each of the plurality of devices on the network supports the MCAP using channel numbers through which a plurality of IGMP report messages was transmitted from the plurality of devices on the network.

2. The method of claim 1, further comprising:
if all of the plurality of IGMP report messages are not received through a channel allocated by the MCAP broadcast message, determining that only some of the plurality of devices on the network support the MCAP.

3. The method of claim 2, further comprising:
broadcasting an MCAP broadcast message ordering all of the plurality of devices on the network to release the allocated channel if all of the plurality of IGMP report messages are not received through the allocated channel.

4. The method of claim 3, further comprising:
broadcasting a second MCAP advertise message having the content of ‘expire time=0’.

5. The method of claim 1, wherein the network is an IEEE1394 network.

6. A multicast communication method on a network, the method comprising:
broadcasting an MCAP advertise message to a plurality of devices on a network;
broadcasting an Internet Group Management Protocol (IGMP) query message to the plurality of devices on the network;
determining whether each of the plurality of devices on the network supports the MCAP using channel numbers through which a plurality of IGMP report messages was transmitted from the plurality of devices on the network; and
performing communication with a corresponding multicast address by using a multicast channel if the plurality of IGMP report messages from all of the plurality of devices to which the MCAP broadcast message was broadcast are received through the multicast channel, and performing communication with the corresponding multicast address by using broadcast channels if only some of the plurality of IGMP report messages from all of the plurality of devices are received through the multicast channel.

7. The method of claim 6, further comprising:
if all of the plurality of IGMP report messages are not received through a channel allocated by the MCAP broadcast message, determining that only some of the plurality of devices on the network support the MCAP.

8. The method of claim 7, further comprising:
broadcasting an MCAP broadcast message ordering all of the plurality of devices on the network to release the allocated channel if all of the plurality of IGMP report messages are not received through the allocated channel.

9. The method of claim 8, further comprising:
broadcasting a second MCAP advertise message having the content of ‘expire time=0’.

10. The method of claim 6, wherein the network is an IEEE1394 network.

11. A method of determining whether a network device supports a Multicast Channel Allocation Protocol (MCAP), comprising:
transmitting a first MCAP advertise message to a first network device;
transmitting a first Internet Group Management Protocol (IGMP) query message to the first network device;
receiving a first IGMP report message from the first network device;
determining whether the first IGMP report message was received on a multicast channel or on a broadcast channel; and
determining that the first network device supports MCAP if the first IGMP report message was received on the multicast channel.

12. The method of claim 11, wherein the transmitting of the first MCAP advertise message and the first IGMP query message are done on the broadcast channel.

13. The method of claim 11, wherein the transmitting of the first MCAP advertise message and the first IGMP query message are done on the multicast channel.

14. The method of claim 11, further comprising:
transmitting the first MCAP advertise message to a second network device;
transmitting the first Internet Group Management Protocol (IGMP) query message to the second network device;
receiving a second IGMP report message from the second network device;
determining whether the second IGMP report message was received on the multicast channel or on the broadcast channel; and
determining that the second network device supports MCAP if the second IGMP report message was received on the multicast channel.

15. The method of claim 14, wherein the first MCAP advertise message includes an expire time field, which is set to indicate a time for maintaining the multicast channel.

16. The method of claim 15, further comprising:
maintaining the multicast channel for the time indicated in the expire time field.

17. The method of claim 16, further comprising:
transmitting a second MCAP advertise message to the first and second network devices in response to determining that at least one of the first and second network devices does not support MCAP, wherein the second MCAP advertise message indicates that the time has expired; and
releasing the multicast channel in response to determining that at least one of the first and second network devices does not support MCAP.

18. The method of claim 17, further comprising:
communicating with the first and second network devices on the broadcast channel.

19. The method of claim 14, further comprising:
communicating with the first and second network devices on the multicast channel in response to determining that both of the first and second network devices support MCAP.

20. The method of claim 14, wherein the transmitting of the second MCAP advertise message and the second IGMP query message are done on the broadcast channel.

21. The method of claim 14, wherein the transmitting of the second MCAP advertise message and the second IGMP query message are done on the multicast channel.

22. A machine-readable medium that provides instructions for determining whether a network device supports a Multicast Channel Allocation Protocol (MCAP), which, when executed by a machine, cause the machine to perform operations comprising:
transmitting a first MCAP advertise message to a first network device;
transmitting a first Internet Group Management Protocol (IGMP) query message to the first network device;
receiving a first IGMP report message from the first network device;
determining whether the first IGMP report message was received on a multicast channel or on a broadcast channel; and
determining that the first network device supports MCAP if the first IGMP report message was received on the multicast channel.

23. The machine-readable medium of claim 22, wherein the transmitting of the first MCAP advertise message and the first IGMP query message are done on the broadcast channel.

24. The machine-readable medium of claim 22, wherein the transmitting of the first MCAP advertise message and the first IGMP query message are done on the multicast channel.

25. The machine-readable medium of claim 22, wherein the instructions cause the machine to perform operations further comprising:
transmitting the first MCAP advertise message to a second network device;
transmitting the first Internet Group Management Protocol (IGMP) query message to the second network device;
receiving a second IGMP report message from the second network device;
determining whether the second IGMP report message was received on the multicast channel or on the broadcast channel; and
determining that the second network device supports MCAP if the second IGMP report message was received on the multicast channel.

26. The machine-readable medium of claim 25, wherein the first MCAP advertise message includes an expire time field, which is set to indicate a time for maintaining the multicast channel.

27. The machine-readable medium of claim 26, wherein the instructions cause the machine to perform operations further comprising:
maintaining the multicast channel for the time indicated in the expire time field.

28. The machine-readable medium of claim 27, wherein the instructions cause the machine to perform operations further comprising:
transmitting a second MCAP advertise message to the first and second network devices in response to determining that at least one of the first and second network devices does not support MCAP, wherein the second MCAP advertise message indicates that the time has expired; and
releasing the multicast channel in response to determining that at least one of the first and second network devices does not support MCAP.

29. The machine-readable medium of claim 28, wherein the instructions cause the machine to perform operations further comprising:
communicating with the first and second network devices on the broadcast channel.

30. The machine-readable medium of claim 25, wherein the instructions cause the machine to perform operations further comprising:
communicating with the first and second network devices on the multicast channel in response to determining that both of the first and second network devices support MCAP.

31. The machine-readable medium of claim 25, wherein the transmitting of the second MCAP advertise message and the second IGMP query message are done on the broadcast channel.

32. The machine-readable medium of claim 25, wherein the transmitting of the second MCAP advertise message and the second IGMP query message are done on the multicast channel.

33. An apparatus to determine whether a network device supports a Multicast Channel Allocation Protocol (MCAP), comprising:
a network;
a first network device that is connected to the network; and
a second network device that supports MCAP and that is connected to the network to transmit a first MCAP advertise message to the first network device, to transmit a first Internet Group Management Protocol (IGMP) query message to the first network device, to receive a first IGMP report message from the first network device, to determine whether the first IGMP report message was received on a multicast channel or on a broadcast channel, and to determine that the first network device supports MCAP if the first IGMP report message was received on the multicast channel.

34. The apparatus of claim 33, wherein the first MCAP advertise message and the first IGMP query message are transmitted on the broadcast channel.

35. The apparatus of claim 33, wherein the first MCAP advertise message and the first IGMP query message are transmitted on the multicast channel.

36. The apparatus of claim 33, wherein the network is an IEEE1394 network.

37. The apparatus of claim 33, further comprising:
a third network device that is connected to the network,
wherein the second network device also transmits the first MCAP advertise message to the third network device on the broadcast channel, the second network device also transmits the first IGMP query message to the third network device on the broadcast channel, the second network device receives a second IGMP report message from the third network device, the second network device determines whether the second IGMP report message was received on the multicast channel or on the broadcast channel, and the second network device determines that the third network device supports MCAP if the second IGMP report message was received on the multicast channel.

38. The apparatus of claim 37, wherein the first MCAP advertise message includes an expire time field, which is set to indicate a time for maintaining the multicast channel.

39. The apparatus of claim 38, wherein the second network device maintains the multicast channel for the time indicated in the expire time field.

40. The apparatus of claim 39, wherein the second network device transmits a second MCAP advertise message to the first and third network devices if the second network device determines that at least one of the first and third network devices does not support MCAP, wherein the second MCAP advertise message indicates that the time has expired, and
wherein the second network device releases the multicast channel in response to determining that at least one of the first and second network devices does not support MCAP.

41. The apparatus of claim 40, wherein the second network device communicates with the first and third network devices on the broadcast channel.

42. The apparatus of claim 37, wherein the second network device communicates with the first and third network devices on the multicast channel if the second network device determines that both of the first and third network devices support MCAP.
